(19) United States
(12) Patent Application Publication
(10) Pub. No.: US 2015/0261813 A1
(43) Pub. Date: Sep. 17, 2015

(54) Method to form a social group for a real time event

(71) Applicant: Siva Prakasa Reddy Pappula, Fremont, CA (US)

(72) Inventor: Siva Prakasa Reddy Pappula, Fremont, CA (US)

(21) Appl. No.: 14/217,368

(22) Filed: Mar. 17, 2014

(51) Int. Cl. G06F 17/30; H04L 12/18

(52) U.S. Cl. CPC G06F 17/30386; H04L 12/1813

(57) ABSTRACT

A method to establish a social group in real time is provided. The method comprises collection of a user's real time event information through a software application provided on the user's computing device. The method further matches the user's interest query with event information of other users kept in the main system server. The system server then identifies various users having common interest information as that of the user and creates a social group of such users.

### CROSS-REFERENCE(S) TO RELATED APPLICATIONS

This application takes priority from U.S. provisional application No. 61/802,106 filed on 15 Mar. 2013

### TECHNICAL FIELD

This disclosure generally relates to social networking, and more particularly to formation of a social group based on real time interest of a user.

### BACKGROUND

The popularity and growth of social network sites and services has increased dramatically over the last few years. Existing social network sites include Facebook, Google+, Twitter, MySpace, YouTube, LinkedIn, Flicker, Jaiku, MYUBO, Bebo and the like. Such social networking sites are typically organized around user profiles and/or collections of content accessible by members of the network. Membership in such social networks is comprised of individuals, or groupings of individuals, who are generally represented by profile pages and permitted to interact as determined by the social networking service.

In many popular social networks, especially profile-focused social networks, activity centres on web pages or social spaces that enable members to communicate and share activities, interests, opinions, status updates, audio/video content, etc. across networks of contacts. Social networking services might also allow members to track certain activities of other members of the social network, collaborate, locate and connect with former acquaintances and colleagues, establish new connections with other members and share various kinds of information among its members.

While social networks are usually comprised of individuals, members might also include companies, restaurants, political parties and event profiles that are represented in a like manner to human members (e.g., profile pages accessible by members of a social network). Individual members typically connect to social networking services through existing web-based platforms via a computing device and/or mobile smartphone. Smartphone and games-based mobile social networking services are other rapidly developing areas.

Whereas, the social networks have made it easy to share information among its users, however, constantly there is a need of presenting the ever increasing information in a better way.

### SUMMARY

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

According to an embodiment of the invention a method to form a social group based on a real time event based query raised by a user is provided. The method further identifies other users having related information to the real time event query raised by the user and forms a group real time so as to facilitate exchange of various information for coordination during the real time event.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

Reference will be made in detail to embodiments of the disclosure, non-limiting examples of which may be illustrated in the accompanying drawing figures (FIGs). The figures may be in the form of diagrams. Some elements in the figures may be exaggerated or drawn not-to-scale; others may be omitted, for illustrative clarity. Any text (legends, notes, reference numerals and the like) appearing on the drawings are incorporated by reference herein. When terms such as “left” and “right”, “top” and “bottom”, “upper” and “lower”, “inner” and “outer”, or similar terms are used in the description, they may be used to guide the reader to orientations of elements in the figures, but should be understood not to limit the apparatus being described to any particular configuration or orientation, unless otherwise specified or evident from context. Different “versions” of elements may be referenced by reference numerals having the same numbers (###) followed by a different letter suffix (such as “A”, “B”, “C”, or the like), in which case the similar elements may be inclusively referred to by the numeric portion (###) only of the reference numeral

FIG. 1 illustrates the block diagram for implementation of a social group.

FIG. 2 illustrates exemplary specific entities that can be formed using the invention.

FIG. 3a illustrates the connection permissions within a social group as according to an embodiment of the invention.

FIG. 3b illustrates various derived privileges between various interconnected social groups in accordance to an embodiment of the invention

FIG. 4 depicts the various access based roles and privileges available to various categories of users.

FIG. 5 illustrates a specific example of sharing messages across interconnected social groups.

FIG. 6 depicts member to member communication within the social group for a specific entity.

FIG. 7 illustrates an individual user as a specific entity.

FIG. 8 illustrates the formation of sub entities within a social group.

FIG. 9 depicts a table to illustrate exemplary services offered by the social group system.

FIG. 9a illustrates a recommendation scheme implementation

FIG. 10 illustrates an example operating environment in which the invention may function.

FIG. 11 is a schematic block diagram of a sample-computing environment

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

The embodiments and aspects thereof may be described and illustrated in conjunction with systems, devices and methods which are meant to be exemplary and illustrative, not limiting in scope. Specific configurations and details may be set forth in order to provide an understanding of the invention(s).

However, it should be apparent to one skilled in the art that the invention(s) may be practiced without some of the specific details being presented herein. Furthermore, some well-known steps or components may be described only generally, or even omitted, for the sake of illustrative clarity.

Reference herein to “one embodiment”, “an embodiment”, or similar formulations, may mean that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

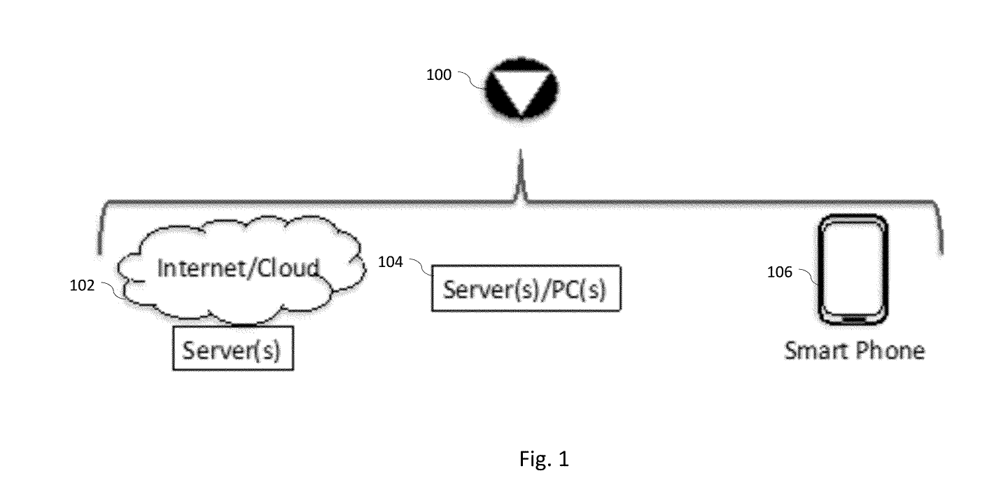

Referring to FIG. 1, which depicts the formation of a social group 100 in various ways. In one embodiment of the invention the social group 100 is implemented through a mobile device 106. This can be achieved through a mobile application on the mobile application. In furtherance to this the implementation to this embodiment can also be achieved by storing some of the content on cloud 102. The information of the social group 100 can be propagated using REST framework or JSON or XML coding.

The logic for creation of the social group 100 can also be stored in various plugins or extensions into any existing mobile applications. The implementation ca also be achieved through web based applications. For this to achieve the process is hosted on a remote server which can be accessed via various protocols such as HTTP/HTTP(s). The logic for creation of the social group 100 can also be written within the applications made for various social media platforms.

In another embodiment of the invention, the social group 100 can also be implemented through a personal computer 104.

The social group 100 however not limiting to the scope of the invention, an application software system. As described above the social group 100 can be implemented as an application running on a mobile device 106 or a personal computer 104 running as an application running on various mobile platforms such as iPhone, Android, Microsoft tablet and other types of computer systems which have given memory and ability to interact with users. The application software system residing on a main server (not shown in the figure) maintains certain information about the social group 100 which may be, however not limiting to the scope of the invention, type of the social group 100, name, certain identifiers, description, keywords, databases, files and objects, users privileges and roles, message filter rules, settings, current location of a user, location history of the user, and other information. The mobile devices 106 or the personal computer 104 can contact the main server to locate other relevant virtual specific entities and gather information about the social group 100. In some embodiments the mobile device 106 may cache various information related to the social group 100 to improve performance and responsiveness to users. Social group systems servers can be implemented as single or groups of servers with facility to back the information, distribute the load and provide high resilience against various failures. In some embodiments, the social group 100 can be created manually, by user specifying the entity details. In other embodiments, the social group 100 may be created automatically by system. For example, automatically creating a social group for all restaurants in a given area. In yet another embodiment of the invention various other social groups can be connected to the social group 100. Also, in some embodiments the social group 100 can be connected to email, web and other interfaces as well.

Explanation for connection formation of social groups:

### Static Connection Formation:

A user may request to identify a set of relevant social groups based on certain key terms or keywords or any other information or any combination thereof. The request of the user is taken by the software application and forwarded to the main server. The main server returns to the user, results related to the query input from him. A set of social groups presented to the user after which if the user may wish he may select either one of the social groups or multiple social groups as per his interest to join. Therefore, the user may also join multiple social groups at a time.

### Dynamic Connection Formation:

As mentioned above in the description connecting to the social group 100, enables users to gather relevant information and discussion. Therefore, dynamic connection formation is provided in order to provide the user facility to find relevant information when he is on the move. This may be based on context, such as events, activities or other interests of the user. The information of the virtualized social entity system is updated so as to indicate the dynamic connections at any point of time as per the user's movement. In one embodiment of the invention the social group 100 can automatically connect to a nearby other virtualized social entities. Connection can be based on user's interest/history or through user's explicit search request. Also, optionally the connection may be automatically terminated when the user is physically away or is not active, from the virtualized social entity to which he was connected dynamically.

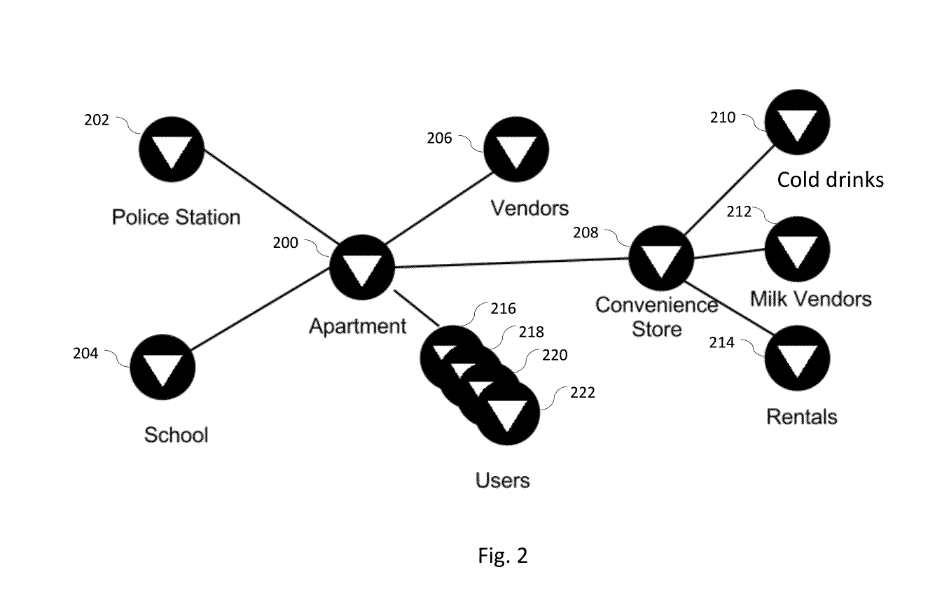

Moving onto FIG. 2, which illustrates a social group 200 connected to another social group 208 and the various services available to the users 216, 218, 220 and 222 within these connected groups. In an exemplary embodiment of the invention, however not limiting to the scope of the invention, a social group could be an apartment 200 which has further other various social groups like police station group 202, school group 204, vendors group 206 like plumber, electrician etc., convenience store group 208 which is further connected to cold drinks services group 210, milk vendors group 212, and rentals group 214 which could be video renting etc. The various users 216, 218, 220 and 222 who are connected to the apartment group 200 can access services in the groups which are connected to the apartment group 200. Hence, a facility is provided to join large number of social groups at once. In the way of example, search for social group can be done using distance as a measure i.e. list all the specific groups which are within 50 miles radius. Once the list of specific groups is returned, user can decide to join all the social groups which are retuned by the query. Social groups can be identified through various factors such as topic of interest, physical distance and other means. Once the social group is detected a request to join the social group is made. In some embodiments, this is accomplished by clicking “Join” button on the screen of a computing device or through a gesture on a touch screen device.

In another embodiment of the invention, connecting to social group helps in gathering relevant information and discussion. To support scenarios where the user is on move and wants to find relevant information based on nearby specific entities or based on context, such as events, activity or other interests, dynamic connections of specific entities is allowed. In one embodiment a given virtual specific entity automatically connects to a nearby specific entities. Optionally, when user is physically away from a dynamically connected social group without any activity then user's connection to a given social group is removed. The users connected with the social group are able to share messages which can be anyone of conversations, chats, news, information, reviews, recommendations, and, questions amongst themselves. The messages shared can be categorized as anyone, but not limiting to the scope of the invention as a global message, a shared message, or a private message.

In yet another embodiment of the invention, in cases where a forum that results into a social group does not have a true physical association i.e. there may be users from various locations of the world who want to participate in a group etc. This forum may be represented as a social group. Users associated with this social group may also be optionally organized into further sub groups with basic attributes for e.g. physical location of users, interests of users etc. Such a sub grouping enables creation of a local sub group so as to enable interaction between local users as well.

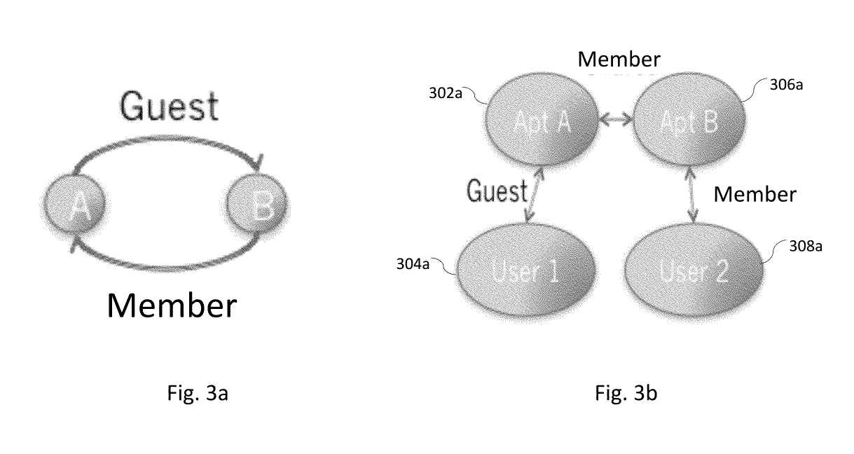

FIG. 3a illustrates the connection permissions within a social group connected to a social group. In an embodiment of the invention a social group can be formed automatically by a system or manually by a user. When a new social group is formed and is connected to another social group then, only public information is accessible by default. Through various authorization methods, other privilege levels such as a member or an owner can be obtained. In one embodiment, this is implemented by user sending an access level request to existing owners. Owner on viewing the request decides the right privilege level for the user.

In another embodiment of the invention different level of access is provided as well Specific Example: as shown in the FIG. 3a user A might have guest level permission on B, but B might have member level access to user A.

FIG. 3b illustrates various derived privileges between various interconnected social groups in accordance to an embodiment of the invention. In an embodiment of the invention Apartment A 302a (depicted as Apt A) is a social group which is connected to Apartment B (depicted as Apt B) 306a. User1 304a belongs to a social group for Apt A 302a. User2 belongs to a social group for Apt B 306a. User1 304a has guest access to Apt A 302a. User2 has member level access to Apt B. Even though Apt A and Apt B have member privilege, User1 will only get guest level access to Apt B.

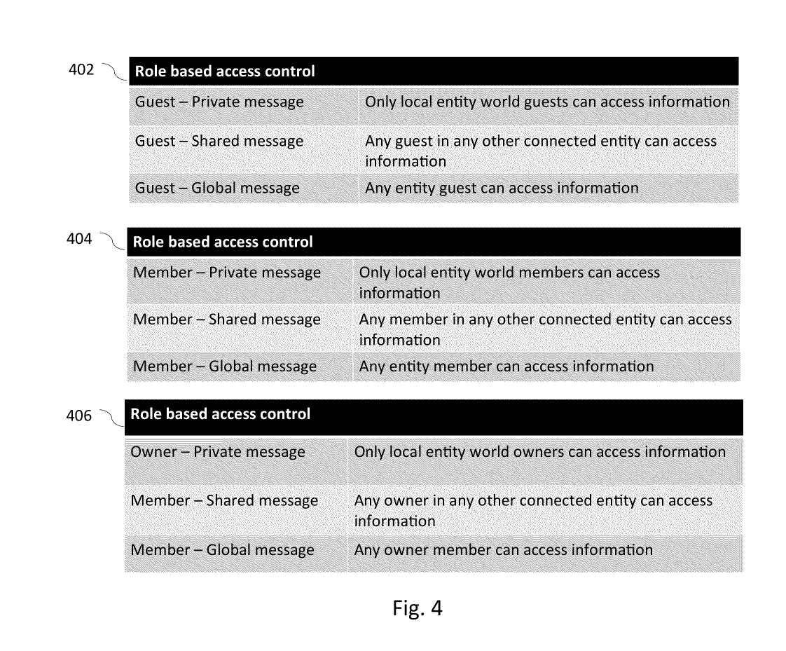

Referring to FIG. 4, it depicts tables to illustrate various types of access that can be provided to users with various types of roles. References will be made to FIG. 2 to explain the context of the invention. As shown in table 402, the role based access control for a user assigned with a guest role within the social group connected to the social group 100. As mentioned above in the description, the information posted by the user can also be further classified into various categories. As table 402 depicts when a guest user posts a private message to the social group 100, this message can be accesses by only those guest users which are connected to the social group 100. However, if the guest user posts a message classified as a shared message to the social group 100, then this message can be accessed by any guest user in any social group connected to the social group 100. Furthermore, if the guest user posts a message classified as a global message, then any guest in any social group can whether connected to the social group 100 or not, can access the message. This is because one user may be connected to multiple specific entities which might or might not be connected to each other.

Further as depicted in table 404 when a member user posts a private message to the social group 100, this message can be accesses by only those member users which are connected to the local social group 100. However, if the member user posts a message classified as a shared message to the social group 100, then this message can be accessed by any member user in any social group connected to the social group 100. Furthermore, if the member user posts a message classified as a global message, then any member in any social group can whether connected to the social group 100 or not, can access the message. This is because one user may be connected to multiple specific entities which might or might not be connected to each other.

Further as depicted in table 406 when an owner user posts a private message to the social group 100, this message can be accesses by only those owner users which are connected to the local social group 100. However, if the owner user posts a message classified as a shared message to the social group 100, then this message can be accessed by any owner user in any social group connected to the social group 100. Furthermore, if the owner user posts a message classified as a global message, then any owner in any social group can whether connected to social group 100 or not, can access the message. This is because one user may be connected to multiple social groups which might or might not be connected to each other.

In another embodiment of the invention, various roles can also be assigned to various connected social groups. For e.g. as depicted in FIG. 2 the Apartment social group 200 which is connected to Police station social group 202 can have anyone of an owner role, a guest role, or a member role.

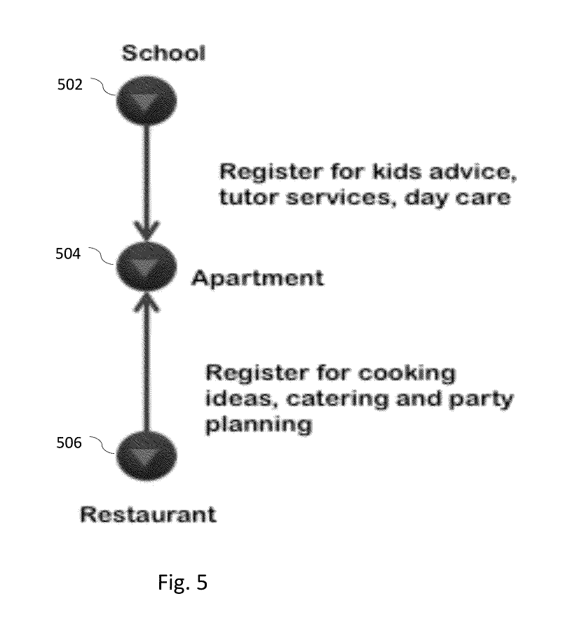

Moving further to FIG. 5, which illustrates message filtering within interconnected social groups. In an embodiment of the invention, a social group can specify set of services and interest a given social group is interested in participating. Based on this information, services and messages to interconnected social groups are limited.

For example, as shown in the FIG. 5, a school social group 502 is connected to an apartment social group 504. The apartment social group 504 is also connected to a restaurant social group 506. According to the invention, the school specific can specify that it is interested in kids and education topics. This limits the school social group to these topics and filter any posts from coming to the school social group from the apartment social group. When a service request is made by a social group, a cyclic connect graph is constructed, using well known computer science algorithms like dijkstra's however, not limiting to the scope of the invention. In this graph message is sent only on links which have proper permission, as described by role based access control. In some embodiments facility is provided for message propagation speeds. For e.g. traverse up to 5 connected social groups per day or post it to communities within 50 miles.

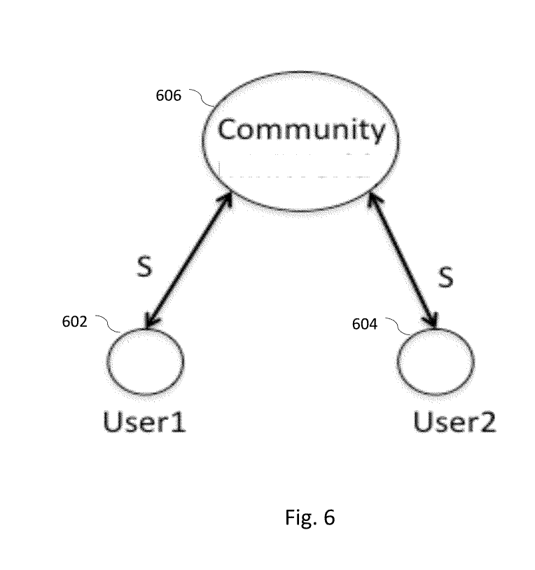

FIG. 6 illustrates a specific member to member communication as per one embodiment of the invention. As shown in the FIG. 6 two member User1 602 and User2 604 are connected to a community social group 606. If the users 602 and 604 are not directly connected to each other, then each user can only see public information of other user. Only after connecting with that user, information with shared or owner level privilege might be accessible. Two users who are not connected via any graph will not be able to reach directly. However, paid service, or by requesting permission from connecting set of social group in a graph is allowed. For e.g. If User1 602 who is not directly connected to User2 604 can request to view User1's 602 information by paying certain amount to community social group 606 to which both User1 602 and User2 604 are connected. To request for User1's 602 details the User2 604 might be required to register himself. This can be done by filing up of an electronic form by the User2 604, to register himself to the social group 606.

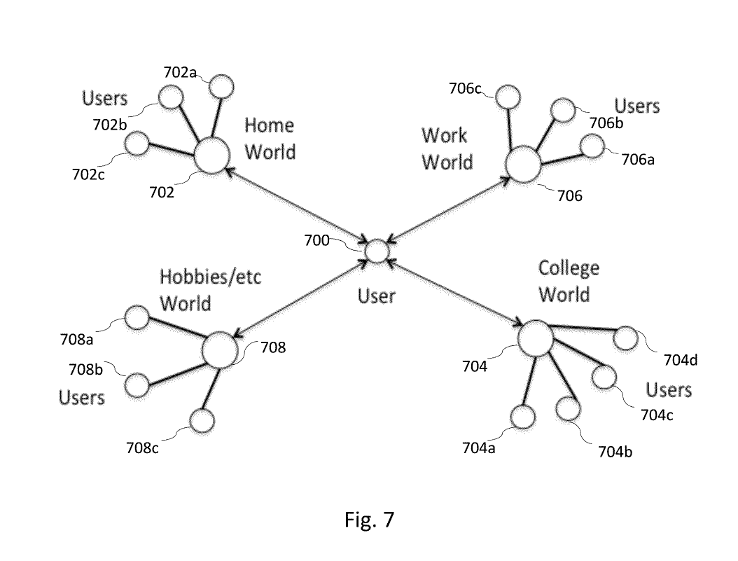

Referring to FIG. 7, as per another embodiment of the invention an individual 700 can also be a social group. In a real group user might end up with set of groups. For example, home 702, work 706, college 704, Hobbies/play 708 etc. A User will have friends, family and acquaintances at each group. In an embodiment of the invention the user 700 can post a specific message to his work group 706 which will be only accessible to users 706a. 706b, and 706c connected to the user 700 through his work group 706. Similarly the user can post a specific message to his Hobbies group 708 which will only be accessible to users 708a, 708b, and 708c connected to the user 700 through his Hobbies group 708. Further, the users 704a, 704b, 704c, and 704d can also see those posts which the user 700 posts to his college group 704. Also, the users 702a, 702b, and 702c can also see those posts which the user 700 posts to his Home group 702.

This setting allows the user 700 to post message to a selected communities to limit the scope of a given information. In addition, system automatically creates set of useful lists, such as all friends, family, friends at home, friends at work, professional network and the like. This enables the user 700 to be selective and share information with these communities. User 700 can use traditional methods such as email to post information to these communities as well.

However, in another embodiment of the invention the user 700 can also decide to share some information between more than one connected groups. For e.g. he may share come information with both the home group 702 and the college group 704 simultaneously.

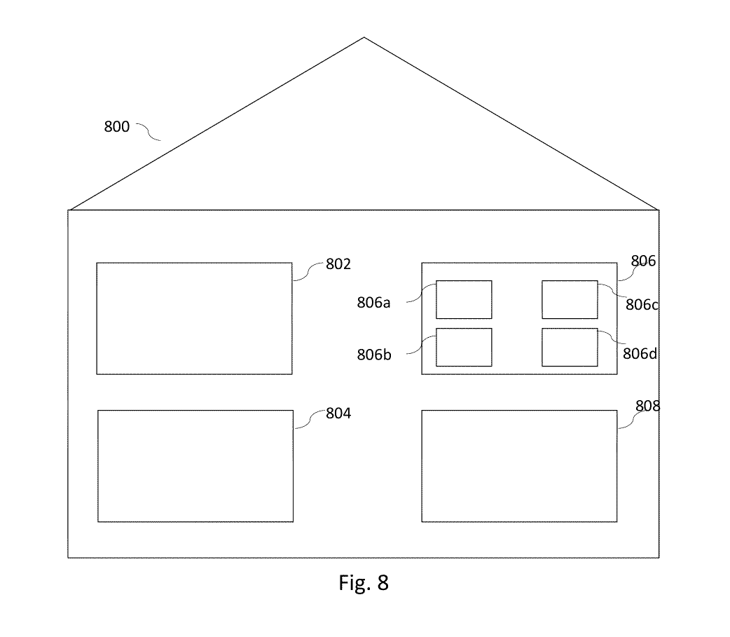

Moving further to FIG. 8 which illustrates formation of various sub groups 802, 804, 806, and 808 within a social group 800. In an embodiment of the invention however, not limiting to the scope of the invention, a social group 800 can be a shopping mall. Since a shopping mall may comprise of many shops hence the mall entity 800 spanning entire mall may not meet the needs of visiting users. Hence, various smaller virtualized sub entities are created for individual stores, brands, etc. within the virtualized mall group 800. In an embodiment, the virtualized mall entity 800 can be further divided into a pharmacy sub group 802, a Daily needs sub group 804, an office supplies group 808, and an electronics sub group 806. In an another embodiment of the invention the electronics sub group can also be further divided into various sub groups like laptops sub group 806a, a washing machine sub group 806b, a television sub group 806c, and a mobile phone sub group 806d.

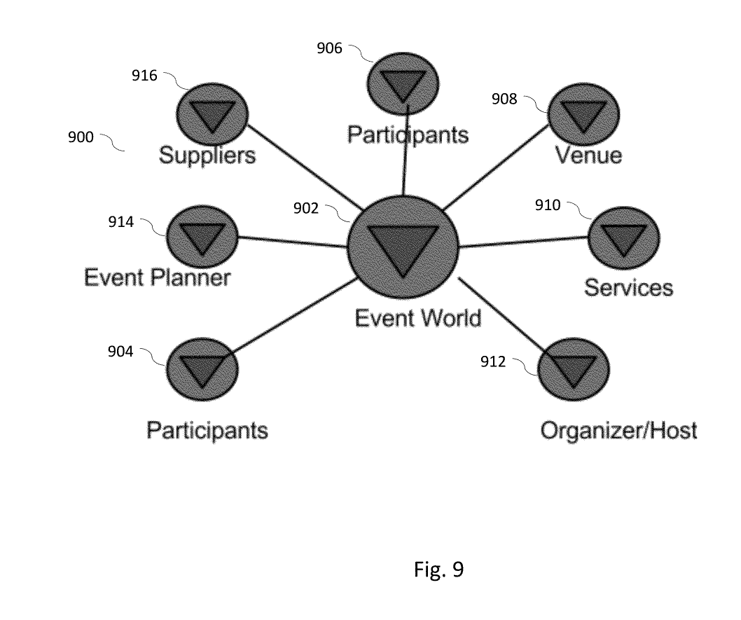

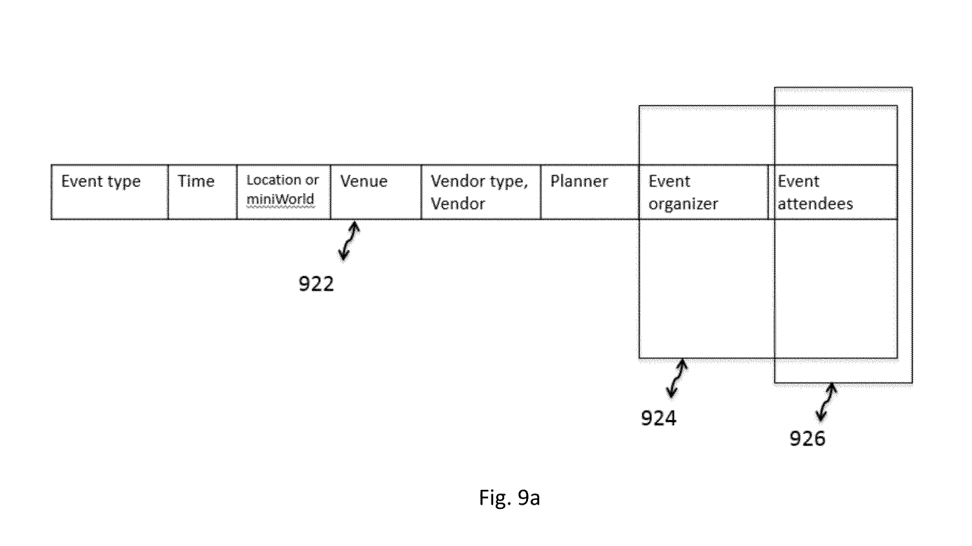

Referring to FIG. 9, illustrating an exemplary embodiment for an event 900 based group formation. The event based group 902 can be formed by any initiating user so as to join various users to the event group 902. Planning and organizing events involves interaction with attendees and also with vendors and others who provide event support. Event group 902 helps simplifying planning, organizing and sharing this information for future uses. Through the event group 902 the initiating user is able to connect to suppliers 916, participants who are performing 906, normal participants 904, event planner 914, organizer/host 912, services for the event 910, and venue services 908.

In an embodiment of the invention event name, with optional location, date, time & duration represents a social group. To support common event activities following event specific services, but not limited to following are provided in this social group.
Guest registration,
Guest tracking (location),
Event scheduling,
Event live streams (Example: Streaming photos, video, blogs etc.,)
Event detection:
Event discovery: Calendar updates with local events
Event auto upload of content:
Event update of content with delay:
Games
Dynamic Quiz etc.,

### Event Data Organization

Event organizational aspects are potentially useful for others to share. Example: Where was the food catered, for a specific type of event? For example kids birthday party. This information is generally is not sensitive i.e. can be shared with others, so that it would be helpful for others to select from already researched vendors.

Event information is split into private and public information. Public information can be accessed for various purposes. Example: Say for Kids birthday planning, similar events in nearby places can be mined to get recommendation/suggestions on venues to hosts, activities to plan and vendors to solicit for food and other services. In addition, facility to reach to users who organized similar events is provided, optionally in an anonymous way.

### Event Hierarchy

In addition to related events, prior events, though may not be related, might benefit from each other from sharing event organization information. To facilitate this event search of public information of previous events is allowed. Example: Birthday party, will result in showing all the events, with results that are most relevant to user shown first. To achieve this location, known persons at an event are taken into account. FIG. 9a shows the event database record. Public information 922 which is available to all users connected to the event group. Event organizer information 924 is only shown if a given user knows the organizer through the social group. Private information 926 is available only to organizer and also used by system to anonymously rank the events.

### Business Aspects:

Businesses which helped with the event such as vendors, owners of venue, planners etc., might get charged for listing their name on the venue

When users are browsing through past events, ads might be displayed which include other vendors and businesses who offer related services. In some cases un-related information might be shown as well.

In some embodiments public events can be searched through various internet facilities. Business can get notified of public events within an area of interest. Example: Community gathering for a public holiday or festival. This allows the business to interact by promoting the event. Depending on the notification method Businesses might get charged. For example, notification about upcoming event via email might cost X units, but notification about upcoming event via SMS might cost Y units, where Y is greater than X. When multiple business entities want to participate they can bid to get spot for online presence & physical presence.

### Guest Registration:

In yet another embodiment of the invention event could be a seminar Therefore, at seminars and others event one of the common task is to get contact information of participants for maintaining on going communication. To facilitate following options are provided.

In one embodiment, for physical event group, when user joins event group, user primary contact information is requested for sharing. In this embodiment, user is prompted with specific information that is requested. For example, name, email address and the likes. Facilities are provided to partially share user information. In one embodiment user can sign in as Guest, Member and Owner level privileges (as explained earlier for FIG. 4), which dictates how the information can be shared further.

For Virtual event groups, when user enters the virtual event group, request for contact information is prompted. In addition to this, at an event group, users have ability to contact other users through event group facility. Through this medium user to user communication is allowed, which helps exchange contact information with other users and also link these users with user's group.

### Guest Tracking (Location)

For event coordination one of the common tasks is to find out where everyone else is. To simplify and automate this, user can share location with the event group. This information can be restricted to selective group of users or can be shared using Owner, Member or Guest settings as well. Vendors can also share the information with the above settings. When user distances are apart, user location view is shown on maps. When they are within building etc., this feature can be set to auto turn off or information can be shown on a building map. By taping the user on the map options to send message, text message, call or videoconference are provided.

### Event Coordination During Event:

For event coordination users can use the resources which provides various file sharing capabilities. This can be used to share the schedules and where every ones needs to be. In addition, users can communicate with each other by sending message, text message, and calling or by videoconferencing. In addition multi-party chat services are also provided.

### Event Scheduling Pre-Event:

Events schedule in some cases is simple, such as picking a date and every one adhering to it. But social events' planning gets complicated as these are based on every ones mutual availability. In cases, though work schedules are typically maintained on calendars, weekend or social calendars are not formally maintained.

To facilitate ease of scheduling, when events are scheduled, in one embodiment, options is given to the guest attending the event to provide preferable time slots. Based on this system can suggest if possible time slot exits or notify users about the conflict. In some embodiments, guests are also allowed to modify the schedule. In such case, when guest changes time, every ones is notified about it.

### Business Aspects:

By utilizing information such as event, event type, number of guests etc., information various business can advertise various services from the pre-event time frame to engage with customer from the beginning stage. As multiple businesses might be interested in providing different services, business can bid on service type, event type, event location area, and other factors. In some embodiments ad is inserted in right place next to the event. For example, next to Food schedule (for example, lunch or dinner) set of vendors who provide food services are shown. Next to activites, set of business who provide activities are shown. Next to event schedule professional planners are shown. In addition various venues can also advertise to host the event at their venue. Next to pictures of hosts or event center of attention ad for professional photo and video graphers is shown.

Referral Generation: As the users of the system can browse through various event and get idea on various vendors and service providers, a record is maintined once the user clicks to get info. When user finally selects a business and connects to it for event coordination of like, then a referall fee is changed. Note different fees might be changed when the user clicks and for estabilishing connection.

### Event Attendance Detection:

Typically as various software and systems are used for event planning detecting user attendance of an event can be challenging. Following options are provided to facilitate automatic detection of events when other event-based systems are used.
Listening to user tag events from well know social media system such as Facebook,
Twitter, Google+ and others
Registering to calendar software on the system
Registering for notification about calendar events from Facebook, Google, Yahoo and others
Listening to new mail notification on the system, which tries to look for invites, calendar mime attachments and other relevant data.

Once event is detected user is prompted to confirm the attendance for the event. If user confirms, then relevant event content is uploaded (as explained earlier). If the event group doesn't exist, then one is created.

To facilitate non users of social group software to join and or to access the content of the social group, URL based access methods are allowed. Via this methods user can explicitly type an email address(es) of the user(s). These names are associated with the resource user has allowed access. In one embodiment, specified users will be able to access the contents of the social group via HTTP or HTTPS protocol. In one embodiment, user on clicking the link is given an option to install the social group software or to explore the shared resource via HTTP or HTTPS methods. In one embodiment, specified user list is stored as part of the marketing campaign. Via this specified users get period remainder about the benefits of the software, including marketing material motivating the users to join. In one embodiment, special incentives are given to attract the users to join the social group.

Event Discovery: Calendar Updates with Local Events

Through the graph of interconnected social groups facility is provided to automatically discover the local events. To control the events, which might be of interest to the user, various control facilities are provided. For example, in one embodiment, user can specify event categories of interest and also specify distance from a location. For example, show all Christmas events happening within 25 miles radius from my home. In yet another embodiment, local events are shown are shown in the interconnected social group event calendar along with users regular events. To visually distinguish non-user event, different color coding schemes or the like are used. In one embodiment, local events are shown in other calendars.

To promote events business can advertise their specific events. Based on the users interests, as described earlier, various events are selected and shown to the user. Business might get charged different rates when user views the ads vs when user clocks on the ad

### Games & Dynamic Quiz Etc.:

To encourage community interaction, in a directly or indirectly connected interconnected social group users can interact with connected users to play live games (also provision is provided to connect with all users to play interactive games, which can accommodate delayed communication Eg. playing one game of chess over one year!).

Simple facilities are provided to user to allow for interactive quiz (where user sets the questions, with multiple choice. Other forms of questions are supported as well). This information is pushed to the connected user for live event. This mechanism can be also utilized to send out surveys. Quiz questions also allow for multi-media elements to be included as well. Quiz questions can be composed live or can be done in offline mechanism. In addition to included games, it is possible to user the list of users connected to play other games, which leverages user presence information from social group. Following describes methods to construct to send a questionnaire/quiz type of question from sender to receiver. Multiple choice, selection and other types of standard questions can be represented in well know XML format.

### Picture Based Questionnaire:

Pictures are embedded in questions. In system pictures are represented by XML tags so that information can be shared. In addition system can track which part of the picture is selected by using the mobile system. Selected image or partial image is taken as feedback. Example: Following is a simple example of asking user to click on one image suitable for the question.

### Video Questionnaire

Traditional methods of playing the video and answering the questions after video play back are provided. In addition, user can click on part of the video, in such cases, video clip information, time from beginning of the clip are tracked. In addition, video clips embedded XML and other metadata at specific places in video. This content is dynamically parsed by the players to build prompt questions at selective places in video clip. In addition, in a video clip, based on the option user has selected, different set of videos are played. Based on user feedback different subsequent stories are displayed.

Though in this method, used to show the questionnaire, same method is also used to show video stories, based on user preference different story is displayed. One example, is same story, based on user age Eg. Less than 5 years, between 5 and 10, more than 18 years, etc., different version of the story are shown. Example, when kids play the video story, parts of the story which has violence are skipped or alternately, images are shown less graphically. In addition, it is also possible to show completely different format of video. Example: kids are displayed animation version and adults are displayed with regular version.

Though this method describes the flow with computer/mobile device type of systems, it is also possible to implement the same with the traditional media like TV, which allows for interactive television shows, in which the user feedback is send to the TV station or in some embodiments, input are send to the DVR and other equipment which is playing the video.

In one embodiment, sender sends the questionnaire to server, specifying the list of receivers. Server on behalf of the sender, sends the questions to selected parities. Results are aggregated and provided with various statistical formats. In addition to included games, it is possible for the user to list users connected at a given social group or location to play other games, which leverages user presence information from social group.

### Resources & Caching:

In some cases at a given social group some information is frequently used. Example: Mall maps in mall, class schedule/material at school etc. Hence, such information can be stored as part of the resource service of a given social group. Information is organized by popularity and relevance in addition to other factors. Also, to make these resources available to users at all times, say even when internet connection is not present and other conditions, following options are used:
Caching of resources and other social group information
Figure out the frequently visited social groups or anticipated to visit social groups and then download selective content (that is frequently used at a given social group and use user preferences and connected social group preference settings to guess)
In cases where the users may not have high speed connection to internet, but have good connectivity to each other, than content from one user can be downloaded (provided appropriate privileges)
Before content is fetched it is checked users at nearby vicinity before content is download from server
In addition torrent type of methods may be used to download the content from multiple parties at the local community to reduce load on a given system and to save battery life of the mobile devices which are acting as senders.

### Travel and Event Prefetching Service:

When user is travelling to a new place, say on vacation etc., places to visit, recommendations and other information is searched to plan for the event. But during the flight and in some cases when tour is to a foreign country, internet access is not available or is very costly or in some cases in very slow, which makes mobile devices hard to use. To provide solution for such and other scenarios through following methods and others, user can indicate the requested information
Parsing the travel and vacation events by looking at the calendar
User manually specifying the information
Travel patterns automatically discovered by the system
Subscribe/Registering the social groups

Once the intent is known, system on behalf of the user searches various information about the intent. For example: If the visit is for vacation, then travel guides, recommendation, users who have visited this place recently and are close to the user, social groups that are of interest are looked up. Information is cached, so that user can browse through it. Social group information is also cached.

In other embodiments during travel ability to automatically discover and connect to relevant social groups in path is also configured in the system. Example: Say during train travel user can discover set of restaurants availed at the station two stops away, and ability to provide the order. In addition, the user can actively communicate the location/presence information to the store so that store has better estimate about their arrival/pickup times

### Cached Information Presentation:

Cached information is organized into set of groups/topics which makes it easy to browse. Eg. For travel purpose, information is organized as travel guides, places to visit, restaurants to try, list of local social groups and so, on. User can specify the size of information that can be cached. Example: 2 Gigabytes. In addition, this cached information can be shared with other users through internet or through near field communication methods.

### Business Solutions

Business might get charged a fees for pre-downloading and showing the content to the user even while offline. System while working offline gather number of view and clicks on links to provide a report back to the business community i.e. advertisers.

Various ads might be cached and display to user at right time by using location, location history, time of day, social interactions and other data. Different rate is applied to cached ads vents normal ads.

Through this method, user can get in touch with the local communities. It helps local communities' offers various services such as bread & breakfast, advice and other information. In addition, various tour/travel guides can be purchased through a subscription model the intent social group and make it available to the users who are visiting.

### Trip Capture:

Detection of trip events through email, schedule or prompting user when new places are detected, along with picture & video activity. Automatically create trip albums. When multiple people are travelling together then in one embodiment, on user permission, combined trip album is created. Pictures are analyzed to detect no user presence and detect well know objects at that place. In such cases user is asked to contribute the picture to online picture database associated with that location. In addition trip group is created. This can be shared with various users. User is given a badge for expertise level.

### Resource Updates:

In addition to viewing resource contents, user can post to the resource services. Content of these can be any digital media information Eg. Photos, videos, text, blogs and the like. On a mobile device, typically carrier internet access is associated with tariff for services such as 3G, 4G and others. Though user might have selected resource, user might opt to update the content to the social group only when free internet access is available (Eg. Through Wifi). To facilitate this, in one embodiment, option is allowed through which user can specify the option. System on detection of free internet access will upload the selected content to the resource services.

### Event Live Stream:

To facilitate updates about events information in various forms such as video, pictures, text, blogs and like are shared near instantaneously with the participants of the event group. Two methods are provided for the sender and receivers to receive the event live stream. 1) Either do updates in live 2) Do updates when high speed and free internet is available. Second option is for the cases where typically there is charge with internet or to conserve battery life of the mobile device. For either of these options, to reduce the amount of bandwidth and storage needed, optional compression facilities are provided.

In addition to live streaming, ability is provided to automatically store the different streams as part of event resource for offline access. In some embodiments, event streams (video, audio, pictures, text etc.,) along with event information can be stored as a website. In some embodiments, events stream can be made available as a media such as DVD.

### Methods of Compression:

To reduce the network bandwidth requirements information is optionally compressed by sender. Receiver decompresses data. Compression typically doesn't yield good results on digital media such as Photos and Videos. To accommodate this, facility is provided to reduce photo resolution and size. This processing can be done either on the event updater such as mobile device and likes or by the server. Similarly to handle video content, facilities are provided to change video code rate, encoding rate or providing a brief sample of the video clip. This processing can be done either by the mobile device or by the server

### Methods for Live Updates:

In an event multiple entities might have new content to post. Also, due to the way of the mobile network it is possible that mobile device to server bandwidth might be less than peer to peer mobile bandwidth. Taking into account these factors, for each event, at a given physical vicinity one tracker is selected. Note: tracer can be remote server. Purpose of the tracker is to maintain a time series data of all the objects (Object here refers to any update for the event such as photos, blogs and the like). In addition tracker also maintains list of nodes that have such data.

### Event Post:

When a system has update, then it updates tracker with the Object details, timestamp of when the object is create, and also maintains timestamp when the object information is shared. Optionally system might update the social group event stream with this information. Note system may chose not to update the object to social group due to network reasons.

### Event Fetch:

For fetching the data two options are provide to user, either to get any update or to get updates only in chronological order occurred. With second option say if a picture is taken 1 PM, but the user already got an update about 1.15 PM event, then 1 PM update is ignored.

### Chronological Update:

Fetcher checks with tracker to see if there are any updates in chronological order since the last update. Fetchers get list of systems that have the data. Based on user configuration, network performance, fetcher fetches specified objects from set of systems. Note: As battery life is critical in mobile device, instead of fetching update from one device, it is preferred to get the set of objects from different set so that each sender have to use the battery for minimum time. Optionally, if object 1 exists in System A and B, then half the file is got from A and half from B. After the fetch is successful fetcher updates the tracker. This can be done once after all fetch operations. Or it can be done for each fetch operation.

### All Update Method:

Tracker based on the knowledge about the objects at fetcher returns list of new objects with corresponding systems that have the object. Fetcher fetches the objects from these system using the scheme mentioned in Chronological update method.

### Security Considerations:

To secure the update and live feedback standard certificate and encryption methods are used. In addition, in some embodiments, to prevent some user from spoofing and join the event sharing, event specific certificates are used. These certificates are distributed automatically by event group before and when the event becomes active.

In another embodiment of the invention typically carrier internet access is associated with tariff for services such as 3G, 4G and others. To avoid using carrier internet charges during event, or to conserve battery life or for other reasons user may decide not to update content live. To facilitate this following method is provided. When preferred internet access is detected, then program scans the content on user device to match the time, place and additional parameter to detect content. User is notified about the action to get permission about the operation. Through the system Graphical interface user can decide to cancel the operation, or selective specific event content to upload. User permissions and also right level of access is obtained from the user (for example, share the content only with my friends at event group). With this information, content is updated to the event stream repository. Based on the access level selected by the user, server notifies the group of users who have this access level at the event are notified about the updates.

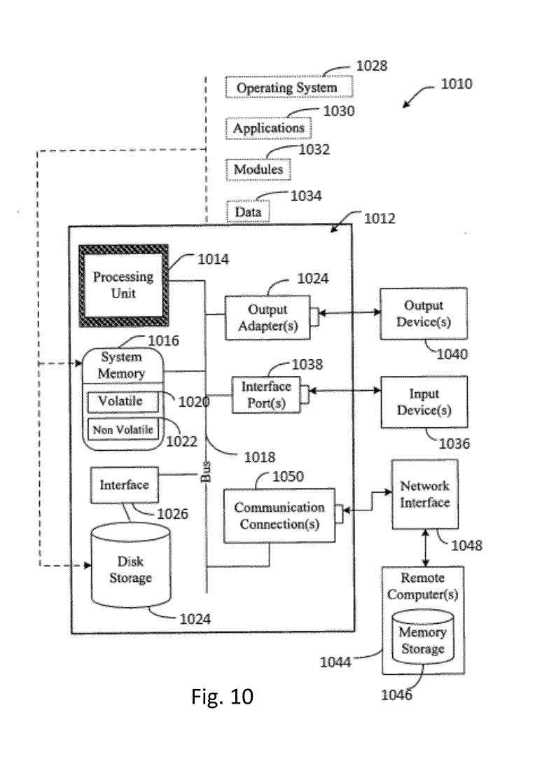

With reference to FIG. 10, an exemplary environment 1010 for implementing various aspects of the subject invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

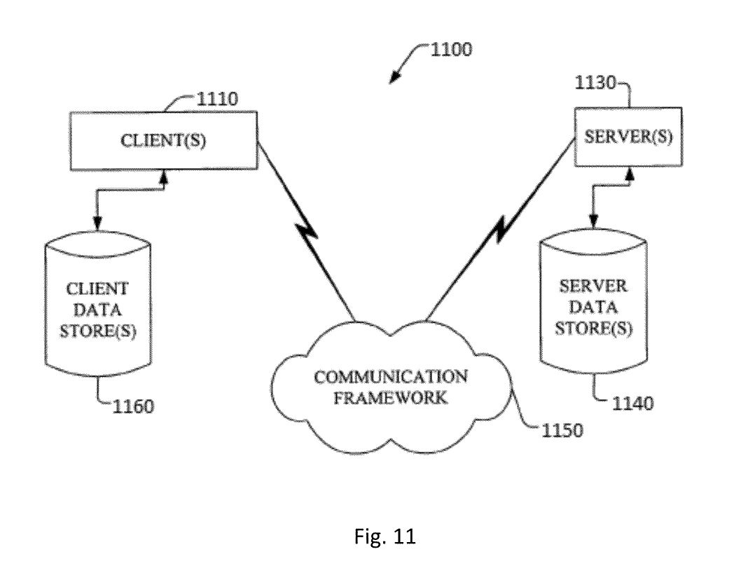

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of establishing a social group, the method comprising:
collecting information about a real time event from an initiating user through a computing device of the initiating user;
comparing the real time event information of the initiating user with real time event information of plurality of other users collected through their respective computing devices, wherein the computing device of the initiating user and the various users are connected through a network;
identifying a set of users having a common real time event information between as to that of the initiating user; and
forming the social group dynamically based on the common real time event information with the initiating user and the set of other users as members of the social group.

2. The method of claim 1, wherein the members are able to post information to the social group.

3. The method of claim 2, wherein the information is posted via anyone of a mobile device, a personal computer, a tablet computer, a wireless computer, or a personal digital assistant.

4. The method of claim 1, wherein the members are able to discover other users or social groups based on their real time event information dynamically.

5. The method of claim 1, wherein the social group is formed on basis of geographic location of the initiating user.

6. The method of claim 1, the initiating user is able to communicate real time with the set of users connected to the social group.
